(19) United States
(12) Patent Application Publication
(10) Pub. No.: US 2025/0147164 A1
(43) Pub. Date: May 8, 2025

(54) METHOD AND DEVICE FOR IDENTIFYING USER'S MOVEMENT

(71) Applicant: Jimbo Robotics inc., Daegu (KR)

(72) Inventor: Sang Cheol LEE, Daegu (KR)

(21) Appl. No.: 18/532,268

(22) Filed: Dec. 7, 2023

(30) Foreign Application Priority Data
Nov. 6, 2023 (KR) 10-2023-0151814

(51) Int. Cl. G01S 13/02; G01S 13/50

(52) U.S. Cl. CPC G01S 13/0209; G01S 13/50

(57) ABSTRACT

The disclosed invention relates to a method for identifying a user's movement using a UWB sensor. In one example, the method comprises the steps of acquiring, by at least one of UWB anchor sensor, signals from a pair of UWB tag sensors each worn on both legs of a user, wherein the UWB anchor sensor is installed within communication range of the UWB tag sensors; processing the acquired signals of the two UWB tag sensors into distance, speed and acceleration signals; calculating a cosine similarity of at least one of the distance, speed and acceleration signals to a reference walking pattern stored in advance; and determining the movement of the user as a walking pattern if calculation result of the cosine similarity is greater than a preset similarity, and otherwise, determining the movement as a non-walking pattern.

### TECHNICAL FIELD

The present invention relates to a method and device capable of accurately identifying whether a user is walking by identifying the user's movements using UWB tag sensors attached to both legs of the user.

### BACKGROUND ART

Recently, various tracking devices that follow the user's movements, such as companion robots, golf trolleys, garbage carts, and photography drones, have been introduced. These tracking devices repeat the motions of running or stopping along with the user while maintaining a certain distance from the moving user. The tracking devices can be used for a variety of uses including practical uses for assisting for the user to perform a task without lifting an object as well as uses for providing psychological stability like a companion robot.

Technologies related to the tracking device are developing day by day, and one of them is the technology that controls the device to accurately follow the user while maintaining the user's safety. To do this, it is necessary to accurately identify or predict what action the user's movement is intended to take. For example, in a situation where the user is simply hanging around rather than trying to walk, if the tracking device responds thereto and repeats the movements, it may cause unnecessary power consumption and, in some cases, cause a safety accident for the user.

Of course, the above problems might be solved by attaching or wearing a large number of sensors to the user to identify and analyze the user's movements, but this is cost-inefficient. Therefore, a method is needed for identifying user behavior patterns, especially specific patterns related to the movement, with a minimum of sensors.

### PRIOR ART LITERATURE

Korean Patent No. 10-2169922 registered on Oct. 20, 2020

### DISCLOSURE OF INVENTION

### Technical Problem

The purpose of the present invention is to provide a method and device capable of accurately identifying the user's movements so that a tracking device that follows a user who walks on both legs can perform tracking only when the user walks, without unnecessary movements.

However, the technical problem to be solved by the present invention is not limited to the above-mentioned problem, and other problems not mentioned can be clearly understood by those skilled in the art from the description of the invention described below.

### Technical Solution

The present invention relates to a method for identifying a user's movement using a UWB sensor. In one example, the method comprises the steps of acquiring, by at least one of UWB anchor sensor, signals from a pair of UWB tag sensors each attached to both legs of a user, wherein the UWB anchor sensor is installed within communication range of the UWB tag sensors; processing the acquired signals of the two UWB tag sensors into at least any one of distance, speed and acceleration signals; calculating a cosine similarity of at least one of the distance, speed and acceleration signals to a reference walking pattern stored in advance; and determining the movement of the user as a walking pattern if the calculation result of the cosine similarity is greater than a preset similarity, and otherwise, determining the movement as a non-walking pattern.

In one embodiment, the UWB anchor sensor is installed in a tracking device, the tracking device may perform tracking the user when the calculation result of the cosine similarity is determined as the walking pattern.

Also, at a time point when the acquired distance signals of the UWB tag sensors are the same, in the case where the tracking device follows forward among the directions of two perpendicular bisectors to the two UWB tag sensors, the direction toward the tracking device may be determined as the walking direction, and in the case where the tracking device follows backward among the directions of the two perpendicular bisectors, the opposite direction that is not toward the tracking device may be determined as the walking direction.

Meanwhile, if the calculation result of the cosine similarity is determined non-walking pattern, when the acquired signals of the UWB tag sensors have a simultaneity greater than a preset criteria, it may be determined as the sitting pattern or the simple back and forth movement pattern.

And, if it is determined as the sitting pattern or the simple back and forth movement pattern, when the magnitude of the acceleration is greater than the preset criteria and there is no substantial change in the magnitude for a certain period of time before or after a drastic increase or decrease in the speed signal, it may be determined as the sitting pattern and otherwise, it may be determined as the simple back and forth movement pattern.

On the other hand, when the acquired signals of the UWB tag sensors do not have simultaneity greater than the preset criteria, it may be determined as an in-place rotation pattern or a hanging-around pattern

And, when the increase and decrease of the distance, speed and acceleration signals are regular and a peak value exists, it is determined as the in-place rotation pattern.

Here, at the time point of the peak value, it may be determined that the user is at 180-degree angle relative to the UWB anchor sensor.

And, when the increase and decrease amplitude of the distance signal is less than a preset value and the cosine similarity of the speed signal and/or acceleration signal is greater than the preset criteria, it may be determined as the hanging-around pattern

According to one embodiment of the present invention, the distance, speed, and acceleration signals may be calculated using a simple moving average.

Meanwhile, in one example, the tracking device provided by the present invention comprises at least one UWB anchor sensor for performing communication with a pair of UWB tag sensors each worn on both legs of a user; and a control unit for receiving distance signals which have been acquired by the UWB anchor sensor from the pair of UWB tag sensors, wherein the control unit configured to: process the acquired signals of the two UWB tag sensors into at least any one of distance, speed and acceleration signals; calculate a cosine similarity of at least one of the distance, speed and acceleration signals to a reference walking pattern stored in advance; and determine the movement of the user as a walking pattern if the calculation result of the cosine similarity is greater than a preset similarity, and otherwise, determine the movement as a non-walking pattern.

The control unit may control the tracking device to perform tracking the user when the calculation result of the cosine similarity is determined as a walking pattern.

Additionally, at a time point when the acquired distance signals of the UWB tag sensors are the same, in the case where the tracking device follows forward among the directions of two perpendicular bisectors to the two UWB tag sensors, the control unit may determine the direction toward the tracking device as the walking direction, and in the case where the tracking device follows backward the directions the among of two perpendicular bisectors, the control unit may determine the opposite direction that is not toward the tracking device as the walking direction.

If the calculation result of the cosine similarity is determined as a non-walking pattern, when the acquired signals of the UWB tag sensors have a synchrony greater than a preset criteria, the control unit may determine the non-walking pattern as a sitting pattern or a simple back and forth movement pattern.

In addition, if the non-walking pattern is determined as the sitting pattern or the simple back and forth movement pattern, when the magnitude of the acceleration is greater than the preset criteria and there is no substantial change in the magnitude for a certain period of time before or after a drastic increase or decrease in the speed signal, the control unit determines the non-walking pattern as the sitting pattern and otherwise, as the simple back and forth movement pattern.

And, when the acquired signals of the UWB tag sensors do not have simultaneity greater than the preset criteria, the control unit may determine the non-walking pattern as an in-place rotation pattern or a hanging-around pattern

For example, when the increase and decrease of the distance, speed and acceleration signals are regular and a peak value exists, the control unit may determine the non-walking pattern as an in-place rotation pattern.

Also, the control unit may determine that at the time point of the peak value, the user is at 180-degree angle relative to the UWB anchor sensor.

And, the control unit may determine the non-walking pattern as the hanging-around pattern when the increase and decrease amplitude of the distance signal is less than a preset value and the cosine similarity of the t speed signal and/or acceleration signal is greater than the preset criteria.

According to one embodiment, the control unit may calculate the distance, speed and acceleration signals using a simple moving average.

### Advantageous Effects

According to the method and device for identifying a user's movement using a UWB sensor of the present invention having the features described above, two UWB tag sensors are attached to the both legs of the user, respectively, and distance information according to time is collected using a UWB anchor sensor, and the collected distance information is processed into distance, speed and acceleration information, thereby accurately determining whether the user is actually walking or is in a non-walking state.

By utilizing such a method and device for identifying the user's movements, the tracking device that follows the user walking on both legs is controlled to perform tracking only when the user walks, without unnecessary movement, and through this, it is possible to reduce power consumption due to repeated unnecessary movements of the tracking device and prevent unpredictable safety accidents.

However, the technical effects that can be achieved through the present invention are not limited to the effects described above, and other effects not mentioned will be clearly understood by those skilled in the art from the description of the invention described below.

### BRIEF DESCRIPTION OF THE DRAWINGS

The following drawings attached to this specification illustrate preferred embodiments of the present invention and serve to make the technical idea of the present invention more understandable, together with the detailed description of the invention described later, and thus the present invention should not be interpreted as limited to only the matters described in such drawings.

FIGS. 1A and 1B are diagrams schematically showing the configuration of a device for implementing a method for identifying user's movements according to an embodiment of the present invention.

FIGS. 2A and 2B are diagrams regarding the movements of the knee joints of both legs of the user when walking.

FIGS. 3A, 3B, and 3C are diagrams showing distance, speed, and acceleration profiles for a walking pattern.

FIGS. 4A and 4B are diagrams illustratively showing the geometric relationship between UWB tag sensors attached to both legs of a user and a UWB anchor sensor.

FIGS. 5A, 5B and 5C show distance, velocity and acceleration profiles for a sitting pattern.

FIGS. 6A, 6B, and 6C are diagrams showing distance, speed and acceleration profiles for a simple back and forth movement pattern.

FIGS. 7A, 7B, and 7C are diagrams showing distance, velocity and acceleration profiles for an in-place rotation pattern.

FIGS. 8A, 8B, and 8C are diagrams showing distance, speed and acceleration profiles for a hanging-around pattern.

FIGS. 9A and 9B are diagrams showing a schematic process for determining the user's movement state.

FIG. 10 is a flowchart of a method for determining a walking pattern and a non-walking pattern.

### BEST MODE FOR CARRYING OUT THE INVENTION

The present invention can make various changes and have various embodiments, and specific embodiments will be described in detail below.

However, the description is not intended to limit the present invention to specific embodiments and should be understood to encompass all changes, equivalents and substitutes falling within the spirit and technical scope of the present invention.

It should be understood that in the present specification, terms such as “comprise” or “have” are intended to specify the existence of features, numerals, steps, operations, components, parts, or the combination thereof described in the specification, not to exclude in advance the possibility of the existence or addition of one or more other features, numerals, steps, operations, components, parts, or the combination thereof.

Additionally, in the present specification, when a part of a layer, membrane, region, plate, etc. is described as being “on” another part, this may include not only being “directly on” the other part, but also cases where there is another part in between. Conversely, when a part of a layer, membrane, region, plate, etc. is described as being “under” another part, this may include not only being “immediately under” the other part, but also cases where there is another part in between. Additionally, in the present specification, being placed “on” may include being placed not only at the upper portion but also at the lower portion.

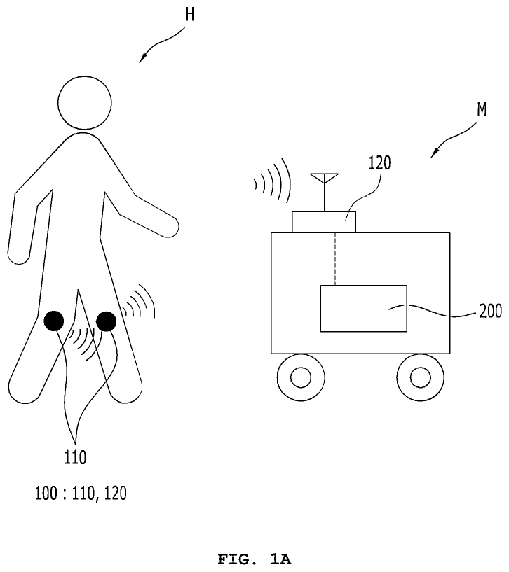

FIGS. 1A and 1B are diagrams schematically showing the configuration of a device for implementing a method for identifying a user's movement according to an embodiment of the present invention. Specifically, the present invention relates to a method for identifying user's movement using a UWB (Ultra-WideBand) sensor 100. The UWB sensor is a near-field wireless communication sensor that uses high-frequency radio waves with a broadband channel of 500 MHz or more, and can very precisely recognize the location (distance) and direction of the surrounding space. In the present invention, the UWB sensor 100 includes a UWB tag sensor 110 provided to the user (H) and a UWB anchor sensor 120 provided in a control unit 200 of the tracking device (M). The UWB tag sensor 110 is provided on the target, the UWB anchor sensor 120 acquires distance information of the target through wireless communication with the UWB tag sensor 110, and the acquired distance information is calculated and processed by the control unit 200.

FIG. 1A shows an example of forward tracking which the tracking device (M) follows the user (H) in front, and FIG. 1B shows an example of backward tracking which the tracking device (M) follows the user (H) from behind. The method for identifying the user's movement of the present invention can be applied to both forward tracking and backward tracking.

The distance information includes time information, and thus the target's velocity information can be obtained by differentiating the distance information, and the target's acceleration information can be obtained by differentiating the velocity information. This distance, speed and acceleration information is relative information of the UWB tag sensor 110 over the UWB anchor sensor 120. Accordingly, it will be fine that the UWB anchor sensor 120 is fixed or moved. Also, the UWB anchor sensor 120 may be fixed to the control unit 200 or may be separated therefrom.

In one embodiment of the present invention, the UWB tag sensor 110 is attached to each of the both legs of the user (H). For example, the UWB tag sensor 110 is a band type and may be worn on the thigh of the user (H). Also, at least one UWB anchor sensor 120 is installed within the communication range of the UWB tag sensor 110.

The fact that the UWB tag sensor 110 is attached to the both legs of the user (H) is based on the very natural fact that people move using their both legs. Also, the both legs of a walking person do not move at the same time, and when moving forward, the both legs have regularity without disorder, and in other cases, the person does not move forward. Therefore, even if only the distance information of each leg of the user (H) is acquired, it is possible to determine whether the user (H) is walking or not.

To this end, the present invention performs the steps of acquiring the signals of the two UWB tag sensors 110 which have been received by the UWB anchor sensor 120, and processing the acquired signals of the two UWB tag sensors 110 into distance, speed and acceleration signals.

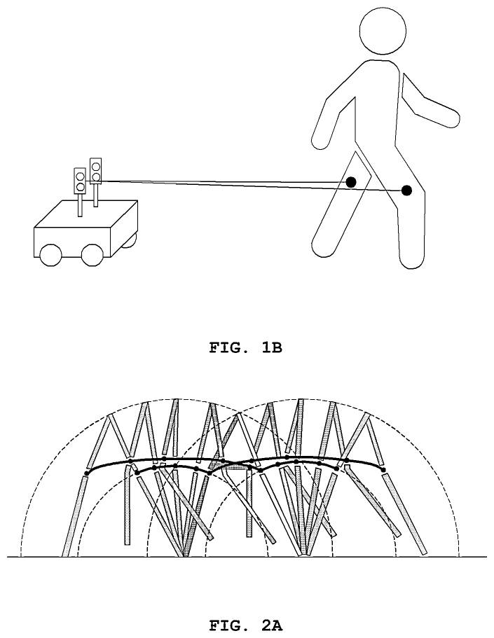

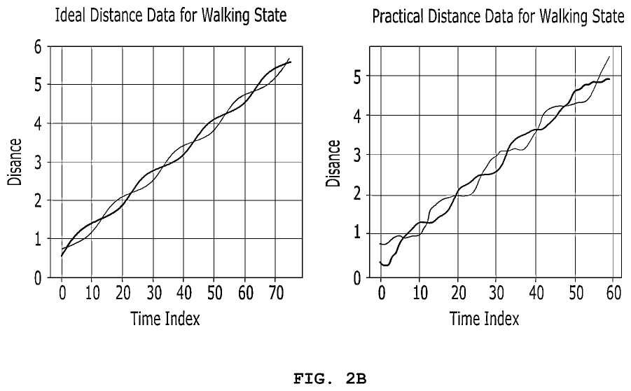

FIG. 2A is a diagram showing the movement pattern of the knee joints of both legs of the user (H) while walking as a trajectory, and FIG. 2B is a diagram showing an ideal pattern and an actually measured pattern of the knee joints of both legs while walking, respectively. It can be confirmed that the actually measured movement pattern of the knee joints of both legs while walking shows a form quite close to the theoretical pattern. Therefore, by attaching the UWB tag sensors 110 to both legs of the user (H), it is possible to identify whether the user (H) is walking or not.

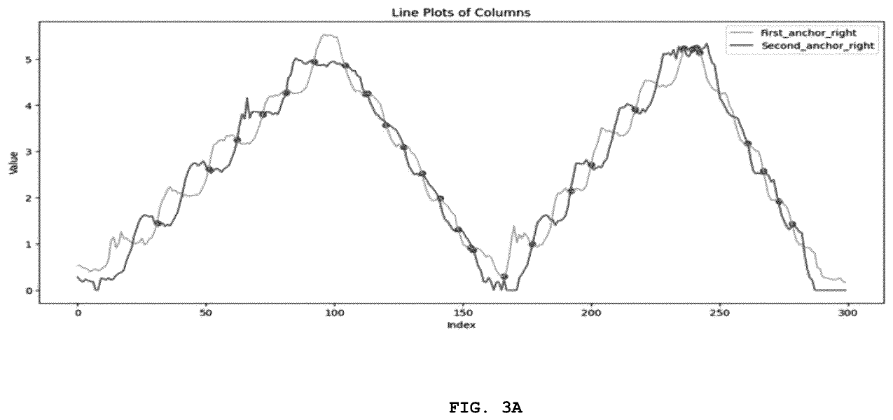

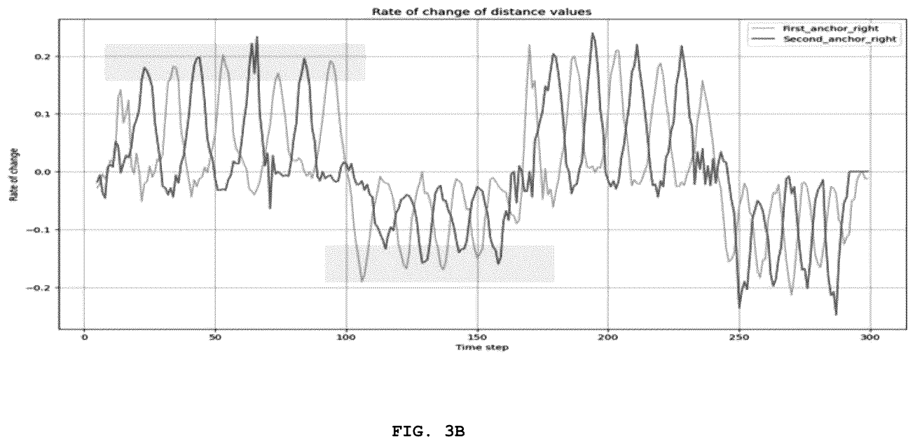

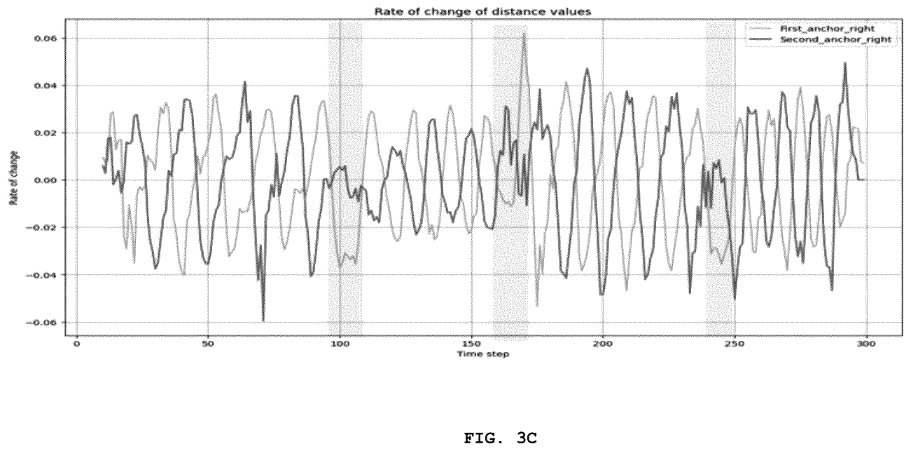

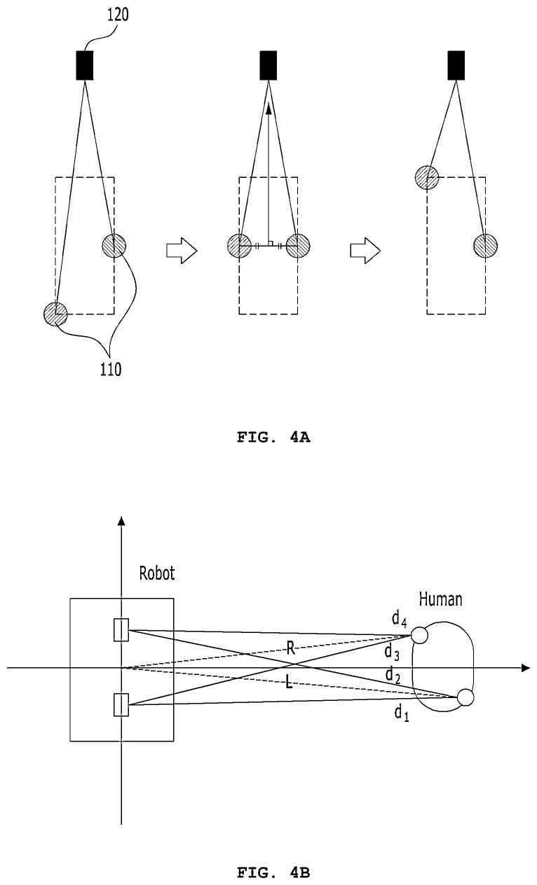

FIGS. 3A, 3B, and 3C are diagrams sequentially showing distance, speed, and acceleration profiles for a walking pattern. Two lines are drawn on each graph in which each line represents the distance, speed, and acceleration of one UWB anchor sensor 120, that is, the left leg and the right leg. For reference, the X-axis of each graph is the time axis.

As will become clearer when compared to the non-walking pattern which will be described later, the walking pattern, that is, the pattern when the user (H) moves forward or backward with respect to the UWB anchor sensor 120, has the following characteristics.

Referring to the distance information, when moving forward or backward with respect to the UWB anchor sensor 120, the pattern of the both legs moving away from each other and getting closer to each other is repeated. In other words, in the state where the pattern of one leg forms the support axis, the pattern in which the other leg moves closer and farther away is repeated, which corresponds to normal walking motion. In other words, in the walking pattern, the simultaneity in which both legs move at the same time does not appear.

And, referring to the speed and acceleration information, when both legs cross similar to pendulum movement, that is, when the distance to the UWB anchor sensor 120 is the same, the speed of the moving legs is maximum and the acceleration is zero. Conversely, when the distance difference between the both legs is greatest, the speed of the moving legs is zero and the acceleration is maximum.

Information that may be additionally obtained is that since a person's walking is generally constant, the speed and acceleration of moving back and forth are almost similar and the magnitude of acceleration immediately after changing the direction of walking from forward to backward or vice versa is somewhat low. For reference, since the distance to the UWB anchor sensor 120 is acquired, the speed when moving forward and getting closer to the UWB anchor sensor 120 is calculated as a minus (−) value and conversely, the speed when moving backward is calculated as a plus (+) value.

Also, referring to FIGS. 4A and 4B, at the time point when the acquired distance signals for the two UWB tag sensors 110 are the same, that is, at the time point when the both legs cross, the direction of the perpendicular bisector to the two UWB tag sensors is determined as the walking direction. This is because when people walk, they rarely meander at an angle to the front of their body. Here, the direction of the perpendicular bisector to the two UWB tag sensors 110 has two directions. Among these directions, the walking direction of the user (H) is determined depending on whether the tracking device (M) follows forward or backward. That is, in the case where the tracking device (M) follows forward as shown in FIG. 1A and FIG. 4A, the walking direction of the user (H) is the direction toward the tracking device (M) among the directions of the two perpendicular bisectors. Whereas, in the case where the tracking device (M) follows backward as shown in Figure (b), the walking direction of the user (H) is the opposite direction that is not toward the tracking device (M) among the directions of the two perpendicular bisectors.

FIG. 4A shows a case where one UWB anchor sensor 120 is installed in the tracking device (M), and FIG. 4B shows a case where two UWB anchor sensors 120 are installed in the tracking device (M). The distance between the user (H) and the tracking device (M) can be measured using the configuration shown in FIG. 4A. Additionally, even the positional relationship between the user (H) and the tracking device (M) can be measured by the configuration shown in FIG. 4B.

This typical walking pattern is stored in the control unit 200 and is used as a reference walking pattern. Then, the similarity of at least one of the distance, speed, and acceleration signals calculated from the distance signals for the two acquired UWB tag sensors 110 to the reference walking pattern stored in advance is determined. This similarity decision is calculated as cosine similarity. The cosine similarity is a method for measuring the similarity of direction, not size that a signal (vector) represents, and by calculating the cosine similarity, it is possible to quantitatively evaluate how similar are the acquired signals of the two UWB tag sensors 110 to the reference walking pattern.

Therefore, if the calculation result of the cosine similarity is greater than a preset similarity, the movement of the user may be determined as a walking pattern and otherwise, the movement of the user may be determined as a non-walking pattern. To increase the accuracy of cosine similarity determination, a cross-validation can be performed on at least two of distance, velocity and acceleration signals. And, in order to alleviate noise in the distance, speed and acceleration signals, the distance, speed and acceleration signals may be calculated using a simple moving average. In particular, since the speed and acceleration signals obtained by differentiation are sensitive to noise or drastic changes, it may be desirable to calculate the signals using such simple moving average.

As mentioned above, according to the method for identifying the user's movement of the present invention, it is possible to determine whether the movement of the both legs of the user (H) corresponds to the walking pattern using only the distance information from a pair of UWB tag sensors 110 attached to the both legs of the user. In addition, a UWB anchor sensor 120 may be installed in the tracking device (M) so that the tracking device M can follow the walking of the user (H) only when the cosine similarity calculation result is determined as a walking pattern. On the contrary, if the calculation result of the cosine similarity is determined as various non-walking patterns which will be described later, the tracking device (M) remains in a standby state. Accordingly, the tracking device (M) performs tracking only when the user (H) walks, without unnecessary movement thereby preventing unnecessary power consumption and reducing the risk of various safety accidents that are difficult to predict.

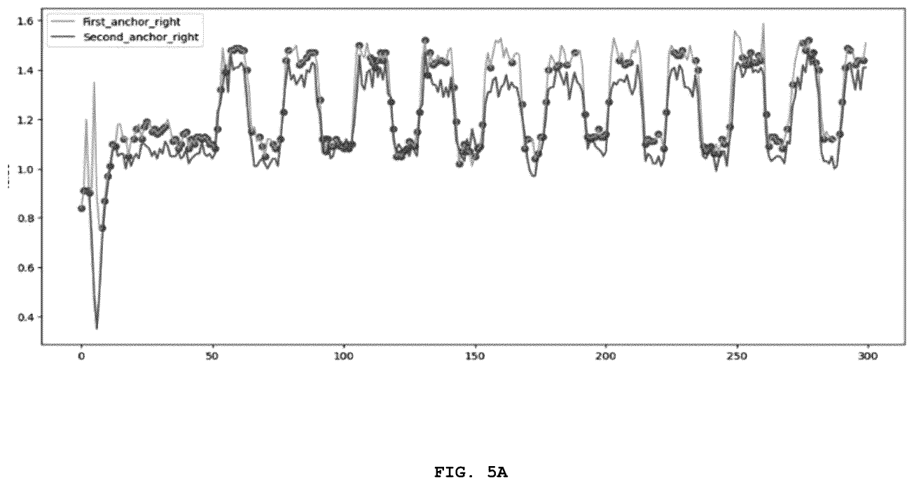

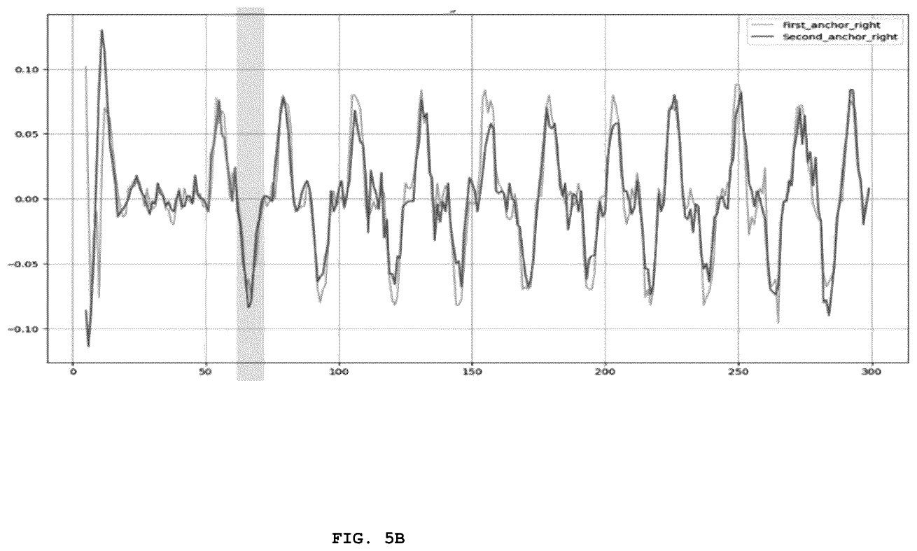

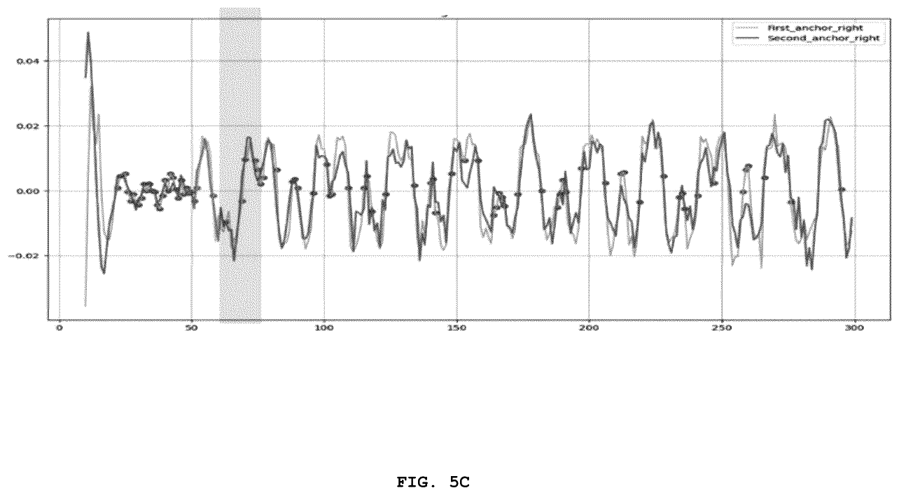

FIGS. 5A, 5B, and 5C through 8A, 8B, and 8C show distance, speed and acceleration profiles for various non-walking patterns. In the present invention, as non-walking pattern that is distinct from walking pattern, a total of four patterns are defined: a sitting pattern, a simple back and forth movement pattern, an in-place rotation pattern and a hanging-around pattern. These non-walking patterns refer to the both legs' movements other than walking that people often make in everyday life.

The non-walking patterns may be grouped into a sitting pattern and a simple back and forth movement pattern, and an in-place rotation pattern and a hanging-around pattern. These two groups of non-walking patterns can be distinguished by the presence or absence of simultaneity.

The term, simultaneity as used in the specification means a pattern in which both legs move simultaneously, that is, the both legs move so that the distance between the two UWB tag sensors 110 with respect to the UWB anchor sensor 120 is the same. Strictly speaking, even if the both legs do not move exactly the same, if the acquired signals from the two UWB tag sensors 110 have simultaneity beyond a preset criteria, for example, if the both legs move the same within a short time of a zero point few seconds, it can be acknowledged to have substantially simultaneity.

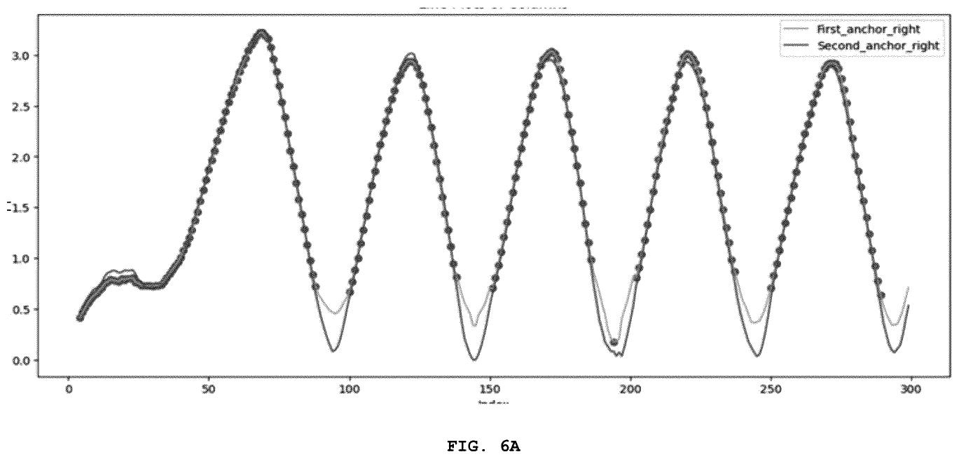

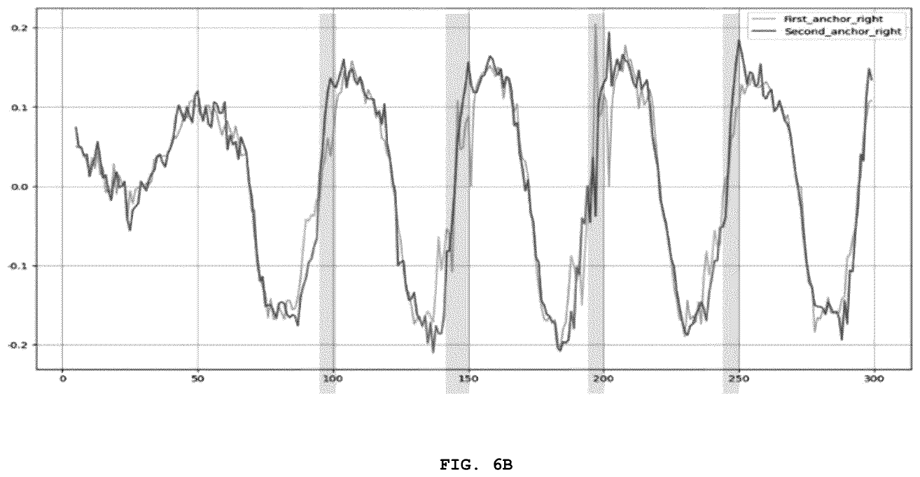

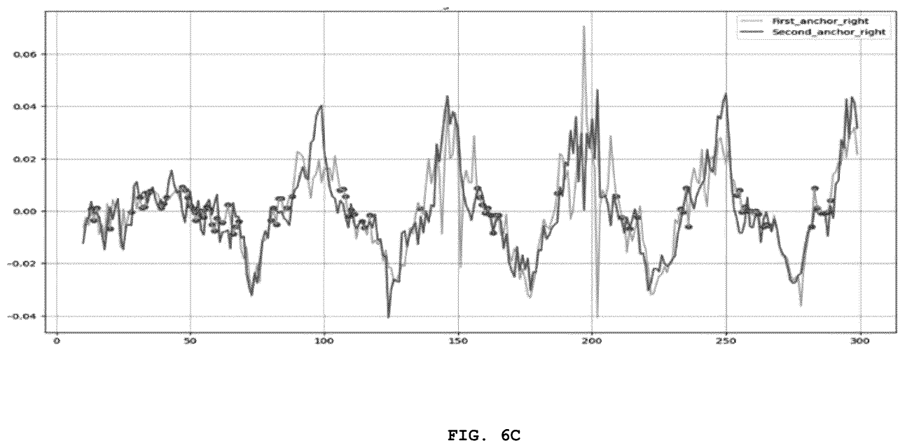

FIGS. 5A, 5B, and 5C are diagrams showing distance, speed and acceleration profiles in a sitting pattern, and FIG. 6 is a diagram showing distance, speed and acceleration profiles in a simple back and forth movement pattern. During sitting and standing movement, both legs move together. In addition, the simple back and forth movement can be assumed when moving by vehicle, for example, when moving while sitting in a wheelchair.

The sitting pattern and the simple back and forth movement pattern have one thing in common in that they have the simultaneity of the movements of both legs, but their detailed characteristics can be distinguished. Referring to the sitting pattern in FIGS. 5A, 5B, and 5C, in the sitting pattern, the distance value of both legs simultaneously goes up and down within a short period of time (in this specification, the sitting pattern includes both sitting and standing movements). Accordingly, the speed and the acceleration during the sitting and standing movements also rapidly increase and decrease. And, since people usually sit still and then stand up, the speed before and after sitting and standing up is close to zero.

In addition, referring to the simple back and forth movement pattern in FIGS. 6A, 6B, and 6C the simultaneity of the both legs is clearly visible in which because it is a state that the distance value changes by moving by the vehicle without movement of the legs, the increase and decrease in the distance, speed and acceleration occur relatively slowly. Also, unlike the sitting pattern, a speed section close to zero before and after the increase or decrease in speed is not clearly found.

Based on this fact, a distinction can be made between a sitting pattern and a simple back and forth movement pattern in which when the magnitude of acceleration is greater than the preset criteria and there is no substantial change in the magnitude of acceleration for a certain period of time before or after a drastic increase or decrease in the speed signal, it can be determined as a sitting pattern and otherwise, as a simple back and forth movement pattern.

If the sitting pattern is found and applied to the tracking device (M), the tracking device (M) can be processed to prepare the tracking mode when the sitting to standing movement is identified. Whether distance, speed, etc. have negative or positive values in the sitting and standing movements depends on whether the UWB anchor sensor 120 is located in front of or behind the user (H), and therefore, it can be determined whether it is a standing movement by taking this into consideration. For example, if the UWB anchor sensor 120 is located in front of the user (H), the distance value increases as the user (H) sits, so the distance value appears as a positive value, and conversely, as the user (H) stands, it appears as a negative value.

And, if the simple back and forth movement pattern is found, it can be used to determine an error in the tracking device (M). In other words, the simple back and forth movement pattern appears even when the user (H) moves by vehicle, but if this simple back and forth movement pattern appears even when the user (H) is standing still, this means that the tracking device (M) is moving alone and as a result, it may be determined that there is an error in the tracking device (M).

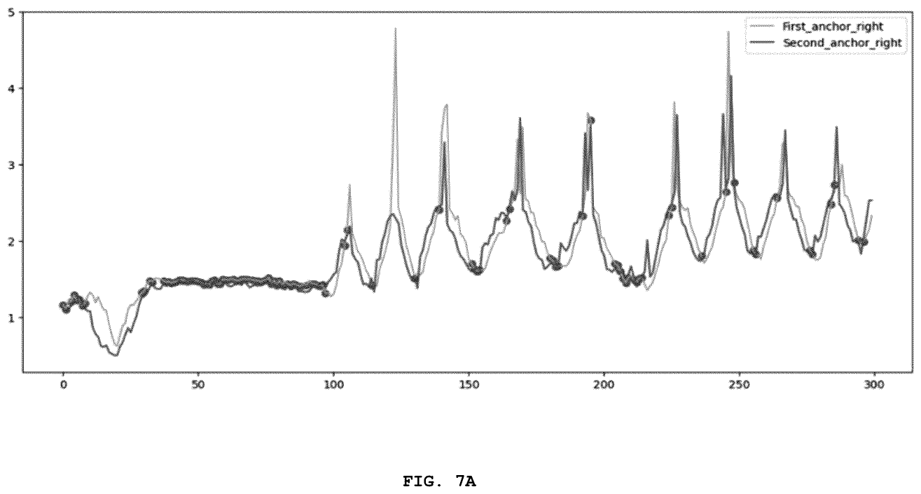

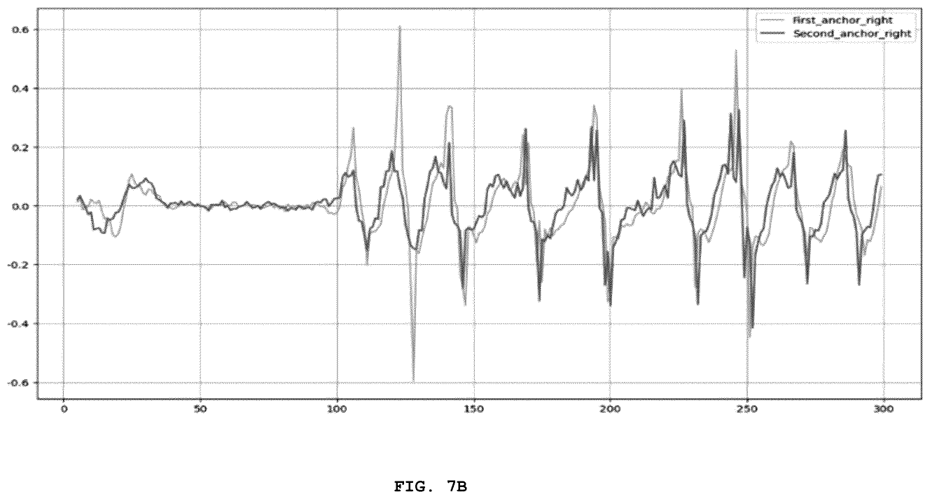

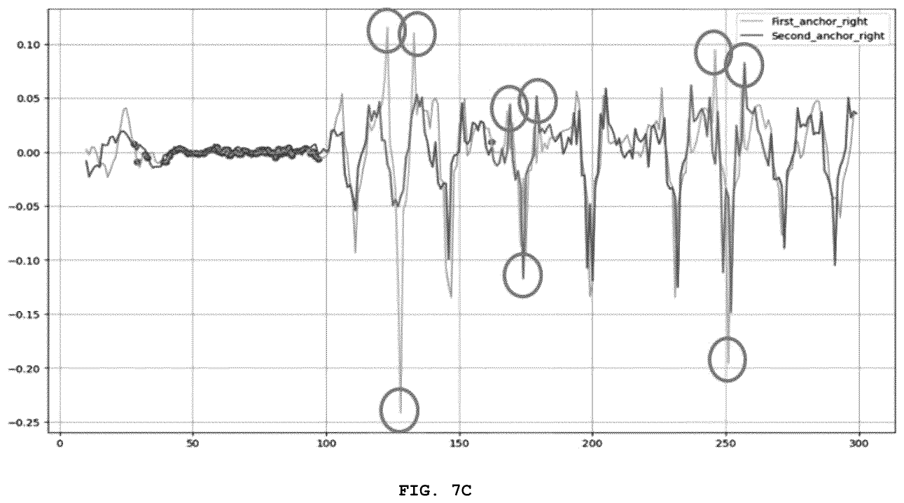

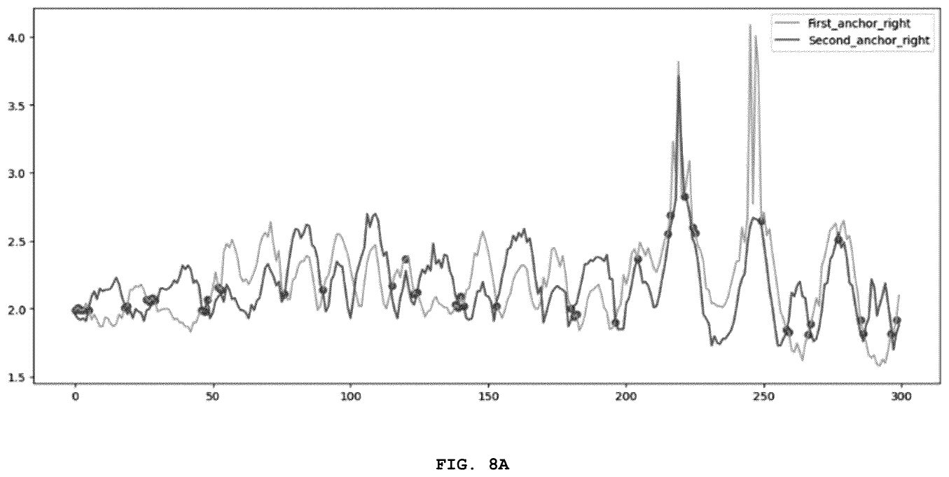

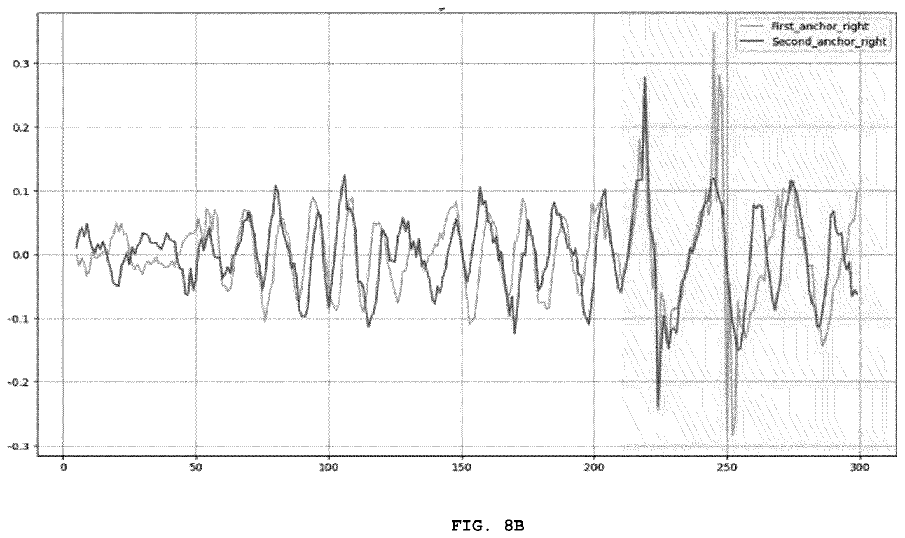

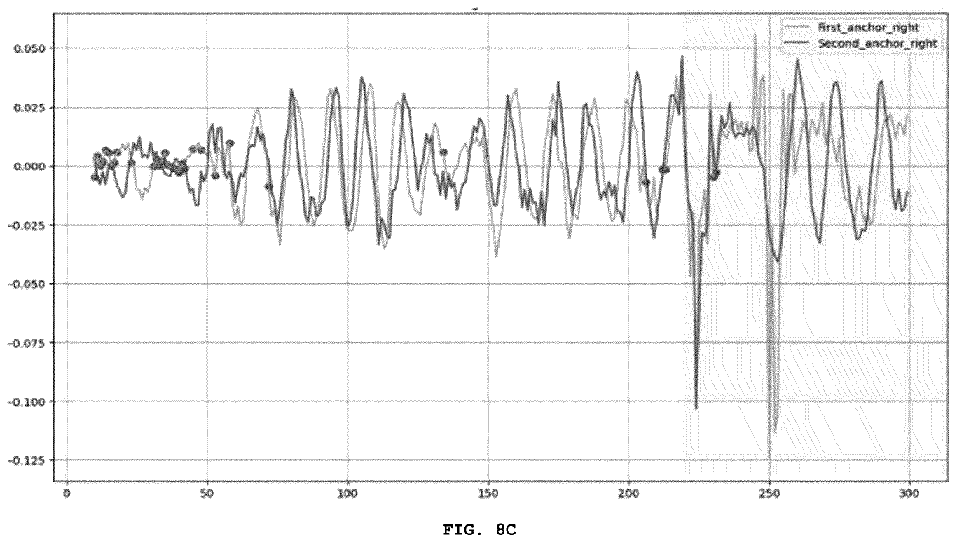

Meanwhile, when the acquired signals of the two UWB tag sensors 110 do not have the simultaneity greater than the preset criteria, it is determined as an in-place rotation pattern or a hanging-around pattern. FIGS. 7A, 7B, and 7C illustratively show distance, speed and acceleration profiles in an in-place rotation pattern, and FIGS. 8A, 8B, and 8C show illustratively distance, velocity and acceleration profiles in a hanging-around pattern.

Referring to FIGS. 7A, 7B, and 7C and 8A, 8B, and 8C, no simultaneity of the both legs is found, such as the sitting pattern or the simple back and forth movement pattern. Therefore, when the acquired signals of the two UWB tag sensors 110 do not have simultaneity greater than the preset criteria, it may be determined as the in-place rotation pattern or the hanging-around pattern.

Next, the in-place rotation pattern and hanging-around pattern may be determined through the characteristics of each pattern as follows. Referring to FIGS. 6A, 6B, and 6C, the in-place rotation pattern shows a kind of wave form in which a pattern that the both legs rotate similarly, the distance increases and decreases and the both legs return to their original positions is repeated. One wave corresponds to one rotation, and in particular, a drastically jumping value, or peak value appears at the inflection point where distance, speed and acceleration increase or decrease. This peak value appears at a position where the user (H) (UWB tag sensor) is at 180° with respect to the UWB anchor sensor 120, that is, the position closest to or farthest from the UWB anchor sensor 120. Accordingly, at the time point of the peak value, it may be determined that the user (H) is at 180° with respect to the UWB anchor sensor 120. Also, if it rotates in place and exceeds 180°, even if the rotation stops midway, it is possible to estimate how many degrees it has rotated using the symmetry of the wave. In other words, the direction in which the user (H) is heading can be determined.

In this respect, if the distance, speed and acceleration signals increase and decrease regularly in the absence of simultaneity of the both legs and a peak value exists, it may be determined as an in-place rotation pattern.

And, referring to the hanging-around pattern in FIG. 8, the distance, speed and acceleration of the both legs follow each other relatively quickly compared to the walking pattern. This is because when a person is hanging around, the person's legs quickly follow each other with regularity and without moving too far apart. Also, because the person is hanging around in place, the distance value does not change significantly within a certain range, and the speed value repeats minus and plus rapidly. Therefore, the increase and decrease amplitude of the distance signal is less than a preset value, and the cosine similarity between the speed and/or acceleration signals of the both legs is greater than the preset criteria (the similarity is high because the both legs rapidly follow each other), it may be determined as the hanging-around pattern.

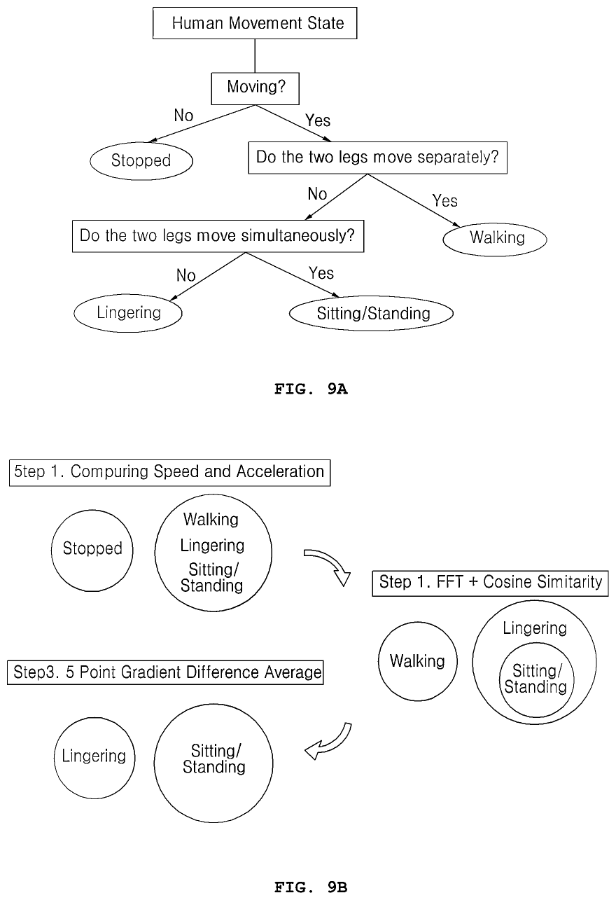

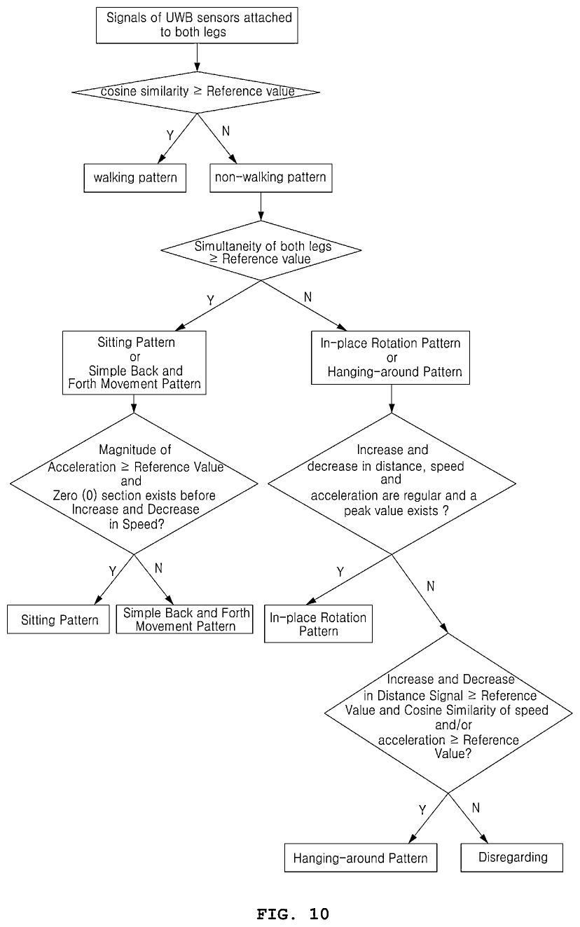

The series of processes for distinguishing between the walking pattern and the non-walking pattern, between the sitting pattern and the simple back and forth movement pattern, and between the in-place rotation pattern and hanging-around pattern as described above are summarized in FIGS. 9A, 9B and 10.

FIG. 9A shows logical steps for defining the movement state of user (H), and FIG. 9B shows a schematic process of determining the movement state of user (H). The specific determination process for the movement state of the user (H) is summarized in detail in the flow chart of FIG. 10. As described above, according to the method for identifying the user's movement using the UWB sensor 100 of the present invention, two UWB tag sensors 110 are attached to the both legs of the user (H), respectively, the UWB anchor sensor 120 collects distance information over time, and the collected distance information is processed into distance, speed, and acceleration information, thereby accurately determining whether the user (H) is actually walking while moving forward or is in a non-walking state without moving forward.

By utilizing the method for identifying the user's movements, the tracking device (M) that follows the user (H) walking on both legs is controlled to perform tracking only when the user (H) walks, without unnecessary movements, thereby reducing the power consumption required for the tracking device (M) to repeat unnecessary movements while simultaneously preventing safety accidents that are difficult to predict.

Meanwhile, the present invention can be implemented by a tracking device (M) that includes a control unit 200 installed with a computer-readable medium storing a program for executing the method for identifying the user's movement as described above and that identifies and follows the user's movement according to the operation of the control unit. As described above, a pair of UWB tag sensors 110 are attached, one on each leg of the user (H). For example, the UWB tag sensor 110 is a band type and may be worn on the thigh of the user. And, a UWB anchor sensor 120 that receives signals from two UWB tag sensors 110 is installed in the tracking device (M). The tracking device (M) includes a control unit 200 which processes the signals of the two UWB tag sensors 110 acquired by the UWB anchor sensor 120 into distance, speed, and acceleration signals. In addition, the control unit 200 determines whether the user (H) is walking, sitting and standing, simply moving back and forth, rotating in place or hanging around based on the calculated and processed distance, speed and acceleration signals. Since the determination algorithm or determination procedure of the walking pattern or non-walking pattern of the control unit 200 is the same as described above, and thus the explanation regarding this will be omitted.

Meanwhile, the method described in this specification may be implemented with a hardware or a combination of the hardware and a software suitable for a specific application. Here, the hardware includes both general-purpose computer devices such as personal computers and mobile communication terminals and enterprise-specific computer devices, and the computer devices may be implemented by a device including, or a combination thereof, memories, microprocessors, microcontrollers, digital signal processors, application integrated circuits, programmable gate arrays, and programmable array logic, etc.

Also, the computer software, instructions, codes, etc. described above may be stored in or accessed by a computer-readable device, in which the computer-readable device includes a computer component having digital information used for computing during a certain time interval, a semiconductor storage such as RAM and ROM, a permanent storage such as optical disk, a massive storage such as hard disk, tape, drum, etc., optical storage such as CD or DVD, a flash memory, a floppy disk, a magnetic tape, a paper tape, stand-alone RAM disk, a massive storage removable from a computer, a dynamic memory, a static memory, a variable storage, and a network-attached storage such as the cloud. Meanwhile, the commands and codes herein include information-oriented languages such as SQL, dBase, etc., system languages such as C, Objective C, C++, assembly, etc., architectural languages such as Java, NET, etc., and application languages such as PHP, Ruby, Perl, Python, etc., but they are not limited thereto and may include all languages widely known to those skilled in the art in the technical field to which the proposed invention belongs.

In addition, “computer-readable medium” as used herein includes all media that contribute to providing instructions to a processor for program execution. Specifically, it includes, but is not limited to, non-volatile medium such as information storage devices, optical disks, magnetic disks, etc., volatile medium such as dynamic memory, and transmission medium such as coaxial cables, copper wires, optical fibers, etc. that transmit information.

The present invention has been described in more detail through the drawings and embodiments as mentioned above. However, since the configuration described in the drawings or examples described in this specification are only one embodiment of the present invention and do not represent the entire technical idea of the present invention and therefore, it should be understood that various equivalents and variations may exist at the time of filing this application.

1. A method for identifying the movement of a user, comprising:
acquiring, by at least one of UWB anchor sensor, signals from a pair of UWB tag sensors each attached to both legs of a user, wherein the UWB anchor sensor is installed within communication range of the UWB tag sensors;
processing the acquired signals of the two UWB tag sensors into at least any one of distance, speed and acceleration signals;
calculating a cosine similarity of at least one of the distance, speed and acceleration signals to a reference walking pattern stored in advance; and
determining the movement of the user as a walking pattern if the calculation result of the cosine similarity is greater than a preset similarity, and otherwise, determining the movement as a non-walking pattern.

2. The method according to claim 1, wherein the UWB anchor sensor is installed in a tracking device, the tracking device performing tracking the user when the calculation result of the cosine similarity is determined as the walking pattern.

3. The method according to claim 1, wherein at a time point when the acquired distance signals of the UWB tag sensors are the same, in the case where the tracking device follows forward among the directions of two perpendicular bisectors to the two UWB tag sensors, the direction toward the tracking device is determined as the walking direction, and in the case where the tracking device follows backward among the directions of the two perpendicular bisectors, the opposite direction that is not toward the tracking device is determined as the walking direction.

4. The method according to claim 1, wherein if the calculation result of the cosine similarity is determined as a non-walking pattern, when the acquired signals of the UWB tag sensors have a simultaneity greater than a preset criteria, it is determined as a sitting pattern or a simple back and forth movement pattern.

5. The method according to claim 4, wherein if it is determined as the sitting pattern or the simple back and forth movement pattern, when the magnitude of the acceleration is greater than the preset criteria and there is no substantial change in the magnitude for a certain period of time before or after a drastic increase or decrease in the speed signal, it is determined as a sitting and otherwise, it is determined as the simple back and forth movement pattern.

6. The method according to claim 4, wherein when the acquired signals of the UWB tag sensors do not have simultaneity greater than the preset criteria, it is determined as an in-place rotation pattern or a hanging-around pattern

7. The method according to claim 6, wherein when the increase and decrease of the distance, speed and acceleration signals are regular and a peak value exists, it is determined as the in-place rotation pattern.

8. The method according to claim 7, wherein at the time point of the peak value, it is determined that the user is at 180-degree angle relative to the UWB anchor sensor.

9. The method according to claim 6, wherein when the increase and decrease amplitude of the distance signal is less than a preset value and the cosine similarity of the speed signal and/or acceleration signal is greater than the preset criteria, it is determined as the hanging-around pattern

10. The method according to claim 1, wherein the distance, speed and acceleration signals are calculated using a simple moving average.

11. A tracking device, comprising:
at least one UWB anchor sensor for performing communication with a pair of UWB tag sensors each worn on both legs of a user; and
a control unit for receiving distance signals which have been acquired by the UWB anchor sensor from the pair of UWB tag sensors, wherein the control unit configured to:
process the acquired signals of the two UWB tag sensors into at least any one of distance, speed and acceleration signals;
calculate a cosine similarity of at least one of the distance, speed and acceleration signals to a reference walking pattern stored in advance; and
determine the movement of the user as a walking pattern if the calculation result of the cosine similarity is greater than a preset similarity, and otherwise, determine the movement as a non-walking pattern.

12. The tracking device according to claim 11, wherein the control unit controls the tracking device to perform tracking the user when the calculation result of the cosine similarity is determined as a walking pattern.

13. The tracking device according to claim 11, wherein at a time point when the acquired distance signals of the UWB tag sensors are the same, in the case where the tracking device follows forward among the directions of two perpendicular bisectors to the two UWB tag sensors, the control unit determines the direction toward the tracking device as the walking direction, and in the case where the tracking device follows backward among the directions of the two perpendicular bisectors, the control unit determines the opposite direction that is not toward the tracking device as the walking direction.

14. The tracking device according to claim 11, wherein if the calculation result of the cosine similarity is determined as a non-walking pattern, when the acquired signals of the UWB tag sensors have a simultaneity greater than a preset criteria, the control unit determines the non-walking pattern as a sitting pattern or a simple back and forth movement pattern.

15. The tracking device according to claim 14, wherein if the non-walking pattern is determined as the sitting pattern or the simple back and forth movement pattern, when the magnitude of the acceleration is greater than the preset criteria and there is no substantial change in the magnitude for a certain period of time before or after a drastic increase or decrease in the speed signal, the control unit determines the non-walking pattern as the sitting pattern and otherwise, as the simple back and forth movement pattern.

16. The tracking device according to claim 14, wherein when the acquired signals of the UWB tag sensors do not have simultaneity greater than the preset criteria, the control unit determines the non-walking pattern as an in-place rotation pattern or a hanging-around pattern

17. The tracking device according to claim 16, wherein when the increase and decrease of the distance, speed and acceleration signals are regular and a peak value exists, the control unit determines the non-walking pattern as an in-place rotation pattern.

18. The tracking device according to claim 17, wherein the control unit determines that at the time point of the peak value, the user is at 180-degree angle relative to the UWB anchor sensor.

19. The tracking device according to claim 16, wherein the control unit determines the non-walking pattern as the hanging-around pattern when the increase and decrease amplitude of the distance signal is less than a preset value and the cosine similarity of the speed signal and/or acceleration signal is greater than the preset criteria.

20. The tracking device according to claim 11, wherein the control unit calculates the distance, speed and acceleration signals using a simple moving average.
